(19) United States
(12) Patent Application Publication
(10) Pub. No.: US 2025/0368283 A1
(43) Pub. Date: Dec. 4, 2025

(54) VEHICLE COMPONENT MOUNTING SYSTEM

(71) Applicants: Hyundai Motor Company, Seoul (KR); Kia Corporation, Seoul (KR)

(72) Inventors: Sang Ok Byun, Hwaseong-Si (KR); Jeong Hyun Choi, Hwaseong-Si (KR); Chul Hoon Chang, Hwaseong-Si (KR); Hae Jung Kang, Hwaseong-Si (KR)

(21) Appl. No.: 18/951,931

(22) Filed: Nov. 19, 2024

(30) Foreign Application Priority Data
Jun. 4, 2024 (KR) 10-2024-0073291

(51) Int. Cl. B62D 65/02

(52) U.S. Cl. CPC B62D 65/028

(57) ABSTRACT

Provided is a vehicle component mounting system, which may include: a floating component configured to move a vehicle component below a vehicle body; a positioning pin connected to the floating component; a vision camera configured to photograph a positioning hole of the vehicle body; and a controller configured to control a movement of the floating component based on a position of the positioning hole of the vehicle body photographed by the vision camera.

### CROSS-REFERENCE TO RELATED APPLICATION

This application is based on and claims the benefit of priority to Korean Patent Application No. 10-2024-0073291, filed on Jun. 4, 2024, in the Korean Intellectual Property Office, the disclosure of which is incorporated herein in its entirety by reference.

### TECHNICAL FIELD

The present disclosure relates to a vehicle component mounting system, and more particularly, to a vehicle component mounting system configured to accurately position and mount a vehicle component with respect to a vehicle body.

### BACKGROUND

Vehicle components such as a high-voltage battery, a suspension, and a subframe may be mounted below a vehicle body at a vehicle assembly site. The vehicle body may be moved above a vehicle component mounting system by a hanger and/or the like, and the vehicle component mounting system may be configured to mount the vehicle components below the vehicle body.

The vehicle component mounting system may include a floating component configured to move the vehicle component to accurately position the vehicle component in a positioning hole of the vehicle body. A positioning pin may be inserted into the positioning hole of the vehicle body so that a vehicle component, such as a high-voltage battery, may be positioned with respect to the vehicle body.

However, it may be difficult to accurately position vehicle component(s) with respect to the vehicle body when the size and position of the vehicle body change. That is, a vehicle component mounting system may have difficulties in positioning and mounting the vehicle component(s) in response to various types of vehicles.

### SUMMARY

The present disclosure solves the above-mentioned problems by providing a vehicle component mounting system configured to accurately position and mount a vehicle component with respect to a vehicle body through a vision camera and a servo actuator.

The technical problems to be solved by the present disclosure are not limited to the aforementioned problems, and any other technical problems not mentioned herein will be clearly understood from the following description by those skilled in the art to which the present disclosure pertains.

According to one or more examples of the present disclosure, a vehicle component mounting system may comprise: a floating component which may be configured to move a vehicle component below a vehicle body; a positioning pin connected to the floating component; a vision camera which may be configured to photograph a positioning hole of the vehicle body; and a controller which may be configured to control a movement of the floating component based on a position of the positioning hole of the vehicle body photographed by the vision camera. The lifting device may be configured to move the floating component upwards and downwards. The floating component may comprise: a base fixed to the lifting device; a moving plate disposed to be movable above the base; and a plurality of servo actuators which may be configured to move the moving plate. Further, the skid plate may be configured to convey the vehicle component above the moving plate.

Additionally, the plurality of servo actuators may comprise: a first servo actuator which may be configured to move the moving plate in a first direction; a second servo actuator which may be configured to move the moving plate in a second direction; and a third servo actuator which may be configured to rotate the moving plate in a rotation direction.

In some instances, the floating component may further comprise: a first intermediate plate which may be configured to move in the first direction by the first servo actuator above the base; and a second intermediate plate which may be configured to move in the second direction by the second servo actuator above the first intermediate plate. Additionally, the floating component may further comprise: a first guide rail; and a first guide block which may be configured to guide a movement of the first intermediate plate, and wherein the first guide rail may be disposed on a top surface of the base and extends in the first direction, and the first guide block may be fixed to a bottom surface of the first intermediate plate.

In some examples, the floating component may further comprise: a second guide rail; and a second guide block which may be configured to guide a movement of the second intermediate plate. The second guide rail may be disposed on a top surface of the first intermediate plate and extends in the second direction, and the second guide block may be fixed to a bottom surface of the second intermediate plate.

Additionally, the floating component may comprise: a third guide rail; and a third guide block which may be configured to guide a rotation of the moving plate. The third guide rail may be disposed on a top surface of the second intermediate plate and extend curvedly to have a constant radius of curvature from a central point of the moving plate. The third guide block may be fixed to a bottom surface of the moving plate.

In some instances, the first servo actuator may comprise: a first housing mounted on a top surface of the base; and a first rod may move forward and backward with respect to the first housing. The first rod may be connected to the first intermediate plate.

Further, the second servo actuator may comprise: a second housing mounted on a top surface of the first intermediate plate; and a second rod which may move forward and backward with respect to the second housing. The second rod may be connected to the second intermediate plate.

Additionally, the third servo actuator may comprise: a third housing mounted on a top surface of the second intermediate plate; and a third rod connected to the moving plate. The third rod may be configured to move forward and backward with respect to the third housing.

Further, a fastening tool may be disposed around the floating component. The fastening tool may be configured to fasten the vehicle component to the vehicle body.

According to one or more examples of the present disclosure, a vehicle component mounting system may comprise: a floating component, which may be configured to move a vehicle component below a vehicle body; a lifting device which may be configured to move the floating component upwards and downwards; a base fixed to the lifting device; a moving plate which may be disposed to be movable above the base; a plurality of servo actuators which may be configured to move the moving plate; and a controller which may be configured to control a movement of the floating component via the plurality of servo actuators. As such, the vehicle component mounting system may accurately position the vehicle component to the vehicle body.

Further, the plurality of servo actuators may comprise: a first servo actuator which may be configured to move the moving plate in a first direction; a second servo actuator which may be configured to move the moving plate in a second direction perpendicular to the first direction; and a third servo actuator which may be configured to rotate the moving plate in a rotation direction.

Additionally, the floating may component further comprise: a first intermediate plate configured to move in the first direction by the first servo actuator above the base; and a second intermediate plate configured to move in the second direction by the second servo actuator above the first intermediate plate.

The first servo actuator may comprise: a first housing mounted to a top surface of the base; and a first rod, connected the first intermediate plate. The first rod may be configured to move forward and backward with respect to the first housing.

The second servo actuator may comprise: a second housing mounted to a top surface of the first intermediate plate; and a second rod, connected to the second intermediate plate. The second rod may be configured to move forward and backward with respect to the second housing.

Additionally, the vehicle component mounting system may further comprise: a positioning pin connected to the floating component; a vision camera configured to photograph a positioning hole of the vehicle body. The controller may be configured to control the movement of the floating component based on a position of the positioning hole of the vehicle body photographed by the vision camera.

According to one or more examples of the present disclosure, a vehicle component mounting system may comprise: a first component which may be configured to move a vehicle component below a vehicle body. The first component may comprise: a base; a moving plate located above the base and configured to move relative to the base; a first intermediate plate located below the moving plate; a second intermediate plate located parallel to the first intermediate plate; a guide rail positioned between the first intermediate plate and the second intermediate plate; and a plurality of servo actuators which may be configured to move the moving plate; a lifting device which may be configured to move the first component upwards and downwards, wherein the base of the first component is fixed to the lifting device; a positioning pin connected to the first component; a camera configured to photograph a positioning hole of the vehicle body; and a controller which may be configured to control a movement of the first component via the plurality of servo actuators based on a position of the positioning hole of the vehicle body photographed by the camera.

Additionally, the first intermediate plate may be configured to move in the first direction by the first servo actuator above the base; and the second intermediate plate may be configured to move in the second direction by the second servo actuator above the first intermediate plate.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a side view of a vehicle component mounting system according to an example of the present disclosure;

FIG. 2 illustrates a plan view of a floating component of a vehicle component mounting system according to an example of the present disclosure;

FIG. 3 illustrates a view, which is viewed in a direction indicated by arrow A of FIG. 2;

FIG. 4 illustrates a view, which is viewed in a direction indicated by arrow B of FIG. 2;

FIG. 5 illustrates a servo actuator, a base, a first intermediate plate, and a second intermediate plate in a vehicle component mounting system according to an example of the present disclosure;

FIG. 6 illustrates a state in which a first servo actuator is connected to a first intermediate plate in a vehicle component mounting system according to an example of the present disclosure;

FIG. 7 illustrates a state in which a second servo actuator is connected to a second intermediate plate in a vehicle component mounting system according to an example of the present disclosure;

FIG. 8 illustrates a state in which a third servo actuator is connected to a moving plate in a vehicle component mounting system according to an example of the present disclosure;

FIG. 9 illustrates a plan view of a state in which a positioning pin of a floating component is not aligned with a positioning hole of a vehicle body in a vehicle component mounting system according to an example of the present disclosure;

FIG. 10 illustrates the calculation of a stroke of a rod of a third servo actuator in a vehicle component mounting system according to an example of the present disclosure; and

FIG. 11 illustrates a flowchart of a method of controlling a vehicle component mounting system according to an example of the present disclosure.

### DETAILED DESCRIPTION

Hereinafter, examples of the present disclosure will be described in detail with reference to the accompanying drawings. In the drawings, the same reference numerals will be used throughout to designate the same or equivalent elements.

Terms such as first, second, A, B, (a), and (b) may be used to describe the elements of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs.

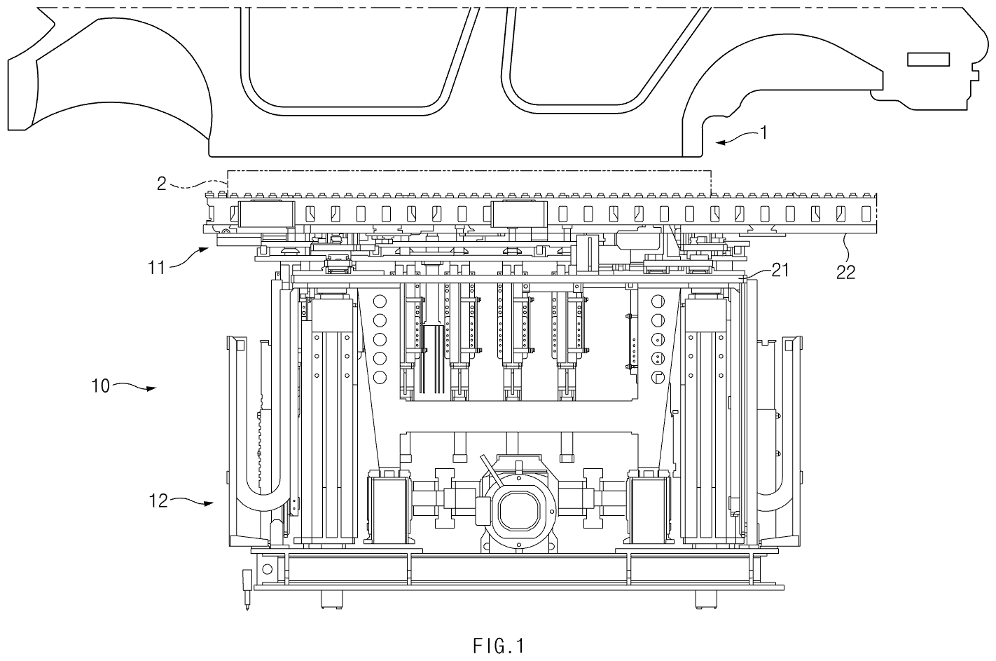

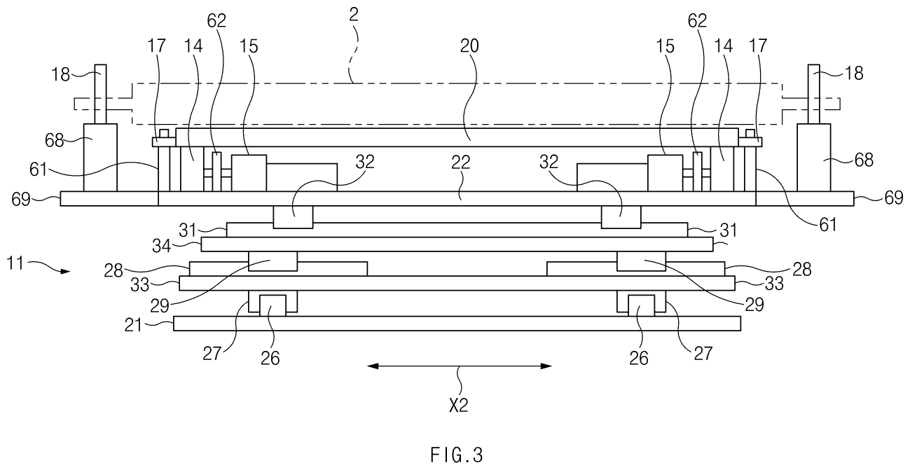

Referring to FIG. 1, a vehicle component mounting system 10 may be configured to mount a vehicle component 2 below a vehicle body 1. The vehicle body 1 may be transferred above the vehicle component mounting system 10 by a transfer component such as a hanger. The vehicle component 2 may include various vehicle components such as a high-voltage battery, a suspension, and a subframe to be mounted below a floor of the vehicle body 1. For example, FIG. 3 illustrates a high-voltage battery, which is mounted below the floor of the vehicle body 1, as the vehicle component 2.

Referring to FIG. 1, the vehicle component mounting system 10 may include a floating component 11 configured to move the vehicle component 2 below the vehicle body 1, and a lifting component 12 configured to move the floating component 11 upwards and downwards.

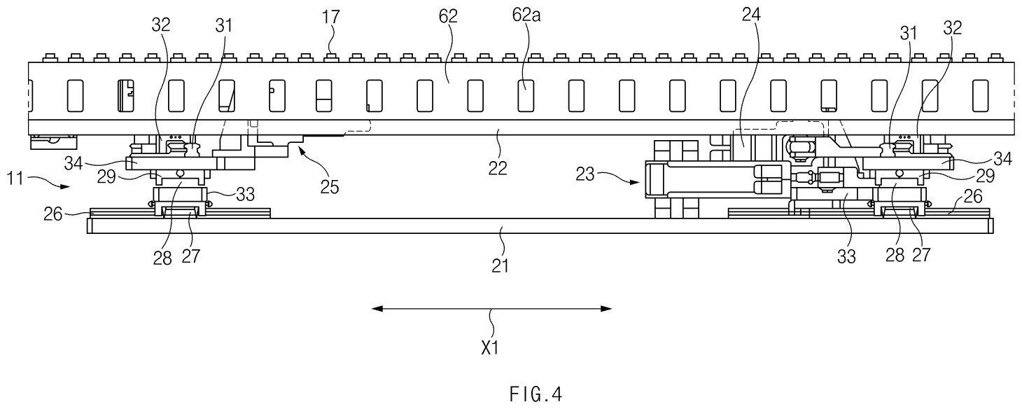

Referring to FIG. 1, the floating component 11 may include a base 21, a moving plate 22 disposed to be movable above the base 21. Referring to FIG. 4, the floating component 11 may include a plurality of servo actuators 23, 24, and 25 configured to move the moving plate 22.

The base 21 may be fixed to the lifting component 12, and the floating component 11 may be configured to move upwards to the vehicle body 1 and downwards from the vehicle body 1 by the lifting component 12.

The moving plate 22 may be configured to move with respect to the base 21 in various directions.

Referring to FIG. 3, the vehicle component mounting system 10 may further include a skid plate 20 conveying the vehicle component 2 above the moving plate 22. The vehicle component 2 may be seated on a top surface of the skid plate 20, and the skid plate 20 may be configured to move and be held above the moving plate 22. For example, the vehicle component 2 may be located above the moving plate 22 of the floating component 11 by the skid plate 20.

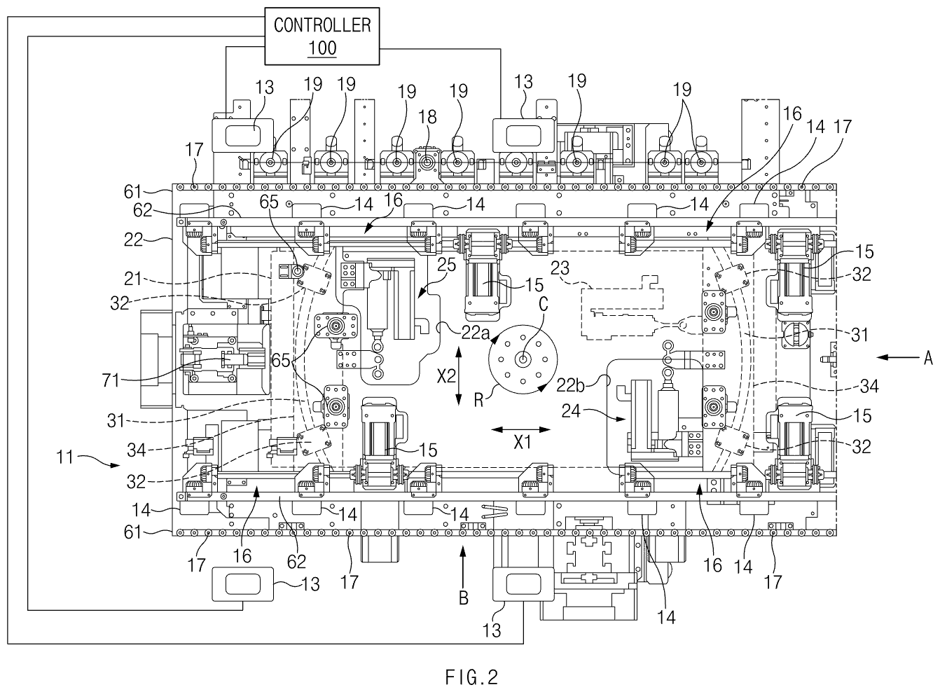

Referring to FIGS. 2 and 3, the moving plate 22 may include a pair of first sidewalls 61 provided at both edges thereof, and a pair of second sidewalls 62 spaced apart from the pair of first sidewalls 61, respectively.

Referring to FIG. 2, the vehicle component mounting system 10 may include a plurality of transfer rollers 14 moving the skid plate 20 above the moving plate 22. The plurality of transfer rollers 14 may be rotatably mounted in spaces defined by the first sidewalls 61 and the corresponding second sidewalls 62, and the plurality of transfer rollers 14 may be rotated by a plurality of drive motors 15. A rotation axis of each transfer roller 14 may extend along a width direction of the moving plate 22. Each drive motor 15 may provide drive power to the plurality of adjacent transfer rollers 14 through an transmission device 16.

Referring to FIG. 3, the skid plate 20 may move above the moving plate 22 by the plurality of transfer rollers 14.

Referring to FIG. 2, the vehicle component mounting system 10 may further include a plurality of guide rollers 17 rotatably mounted on a top surface of each first sidewall 61. As the plurality of guide rollers 17 are in rolling contact with both side surfaces of the skid plate 20, the plurality of guide rollers 17 may be configured to guide the movement of the skid plate 20. A rotation axis of each guide roller 17 may extend vertically, and the rotation axis of the guide roller 17 may be perpendicular to the rotation axis of the transfer roller 14.

Referring to FIG. 2, the vehicle component mounting system 10 may further include a plurality of sensors 65 disposed on a top surface of the moving plate 22. The plurality of sensors 65 may be configured to detect the position of the skid plate 20. For example, each sensor may be position sensor, optical sensor, or photo sensor.

Referring to FIG. 2, the moving plate 22 may further include a stopper cylinder 71 located on a front portion thereof. When the skid plate 20 is accurately positioned in an assembly position above the moving plate 22, the stopper cylinder 71 may be configured to regulate the position of the skid plate 20 above the moving plate 22. As the skid plate 20 is regulated by the stopper cylinder 71 above the moving plate 22, the skid plate 20 may move together with the moving plate 22.

Referring to FIG. 2, the plurality of servo actuators 23, 24, and 25 may include a first servo actuator 23 configured to move the moving plate 22 in a first direction X1. Further, a second servo actuator 24 may be configured to move the moving plate 22 in a second direction X2. Additionally, a third servo actuator 25 may be configured to rotate the moving plate 22 in a rotation direction R. Accordingly, the moving plate 22 may move in the first direction X1 by the first servo actuator 23 above the base 21, the moving plate 22 may move in the second direction X2 by the second servo actuator 24 above the base 21, and the moving plate 22 may rotate in the rotation direction R by the third servo actuator 25 above the base 21. For example, the first direction X1 may be a direction extending in a longitudinal direction of the vehicle body 1, the second direction X2 may be a direction extending in a width direction of the vehicle body 1, and the rotation direction R may be a rotation direction on a central point C of the moving plate 22. Each of the servo actuators 23, 24, and 25 may be an actuator such as a servo cylinder or a servo motor.

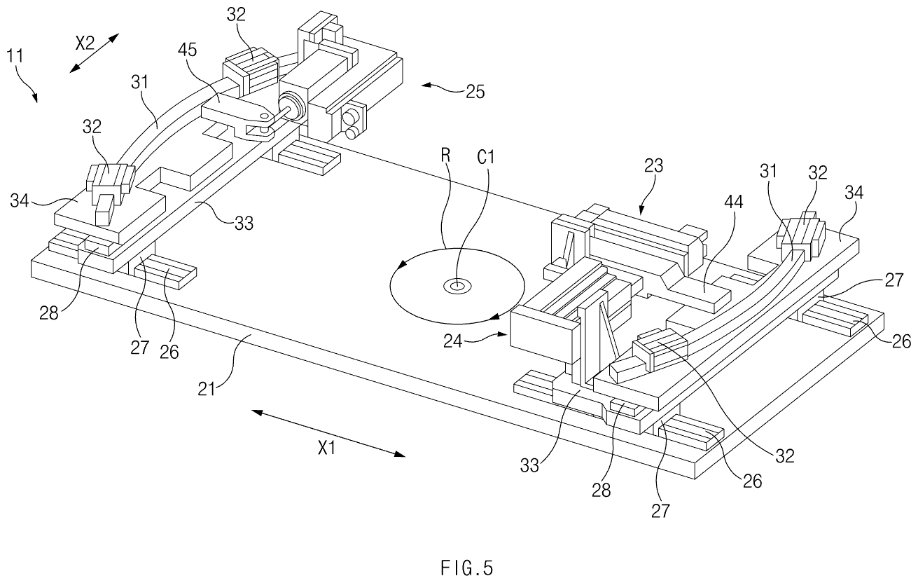

Referring to FIG. 5, the floating component 11 may include a first intermediate plate 33 configured to move in the first direction X1 by the first servo actuator 23 above the base 21, and a second intermediate plate 34 configured to move in the second direction X2 by the second servo actuator 24 above the first intermediate plate 33. A longitudinal axis of the first intermediate plate 33 and a longitudinal axis of the second intermediate plate 34 may extend in the second direction X2. The first intermediate plate 33 may be parallel to the second intermediate plate 34. Referring to FIG. 4, and the second intermediate plate 34 may be disposed below the moving plate 22.

The floating component 11 may include a first guide rail 26 and a first guide block 27 configured to guide the movement of the first intermediate plate 33. The first guide rail 26 may be disposed on a top surface of the base 21 and extend in the first direction X1, and the first guide block 27 may be fixed to a bottom surface of the first intermediate plate 33 and slide along a longitudinal direction of the first guide rail 26.

Referring to FIGS. 3 and 4, the plurality of first guide rails 26 may be fixed to the top surface of the base 21, and a longitudinal axis of each first guide rail 26 may extend in the first direction X1. A plurality of first guide blocks 27 may be fixed to the bottom surface of the first intermediate plate 33. The first guide blocks 27 may slide along the corresponding first guide rails 26, respectively, and the movement of the first intermediate plate 33 may be guided in the first direction X1 by the first guide rails 26 and the first guide blocks 27.

The floating component 11 may include a second guide rail 28 and a second guide block 29 configured to guide the movement of the second intermediate plate 34. The second guide rail 28 may be disposed on a top surface of the first intermediate plate 33 and extend in the second direction X2. The second guide block 29 may be fixed to a bottom surface of the second intermediate plate 34 and slide along a longitudinal direction of the second guide rail 28.

Referring to FIGS. 3 and 4, a plurality of second guide rails 28 may be fixed to the top surface of the first intermediate plate 33, and a longitudinal axis of each second guide rails 28 may extend in the second direction X2. A plurality of second guide blocks 29 may be fixed to the bottom surface of the second intermediate plate 34. The second guide blocks 29 may slide along the corresponding second guide rails 28, respectively, and the movement of the second intermediate plate 34 may be guided in the second direction X2 by the second guide rails 28 and the second guide blocks 29.

The floating component 11 may include a third guide rail 31 and a third guide block 32 configured to guide the rotation of the moving plate 22. The third guide rail 31 may be disposed on a top surface of the second intermediate plate 34 and may extend curvedly to have a constant radius of curvature from the central point C of the moving plate 22, as shown in FIG. 2. The third guide block 32 may be fixed to a bottom surface of the moving plate 22 and slide along a longitudinal direction of the third guide rail 31.

Referring to FIGS. 3 and 4, a third guide rails 31 may be fixed to the top surface of the second intermediate plate 34, and a plurality of third guide blocks 32 may be fixed to the bottom surface of the moving plate 22. The plurality of third guide blocks 32 may slide along the corresponding third guide rails 31, and the rotation of the moving plate 22 may be guided in the rotation direction R(referring to FIG. 2) by the third guide rails 31 and the third guide blocks 32.

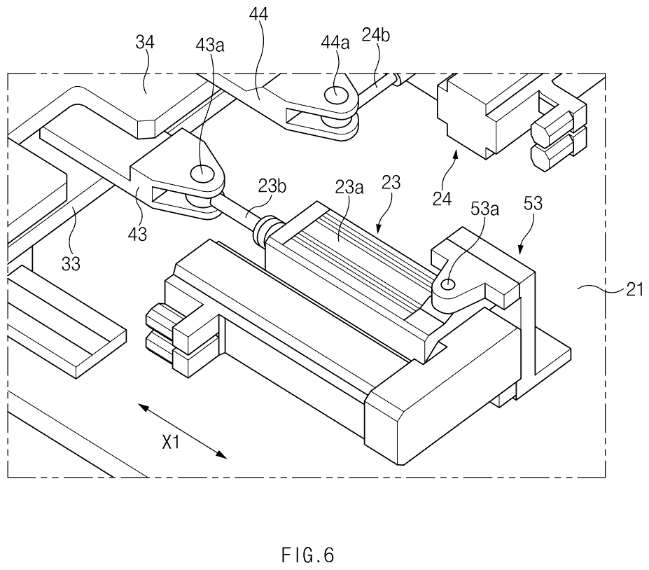

Referring to FIG. 6, the first servo actuator 23 may include a first housing 23a, and a first rod 23b moving forward and backward with respect to the first housing 23a. The first housing 23a may be mounted on the top surface of the base 21 through a first bracket 53, and accordingly the first servo actuator 23 may move the first intermediate plate 33 in the first direction X1 above the top surface of the base 21. The first bracket 53 may be fixed to the base 21, and the first housing 23a may be pivotally connected to the first bracket 53 through a pivot pin 53a. A longitudinal axis of the first housing 23a may extend in the first direction X1, a longitudinal axis of the first rod 23b may extend in the first direction X1, and the first rod 23b may move forward and backward with respect to the first housing 23a in the first direction X1. The first rod 23b may be connected to the first intermediate plate 33 through a first connection block 43. One end of the first connection block 43 may be connected to the first rod 23b through a pivot pin 43a, and the other end of the first connection block 43 may be fixed to the first intermediate plate 33 through a plurality of fasteners. A longitudinal axis of the first connection block 43 may extend in the first direction X1. As the first rod 23b moves forward and backward with respect to the first housing 23a in the first direction X1, the first connection block 43 and the first intermediate plate 33 may move in the first direction X1.

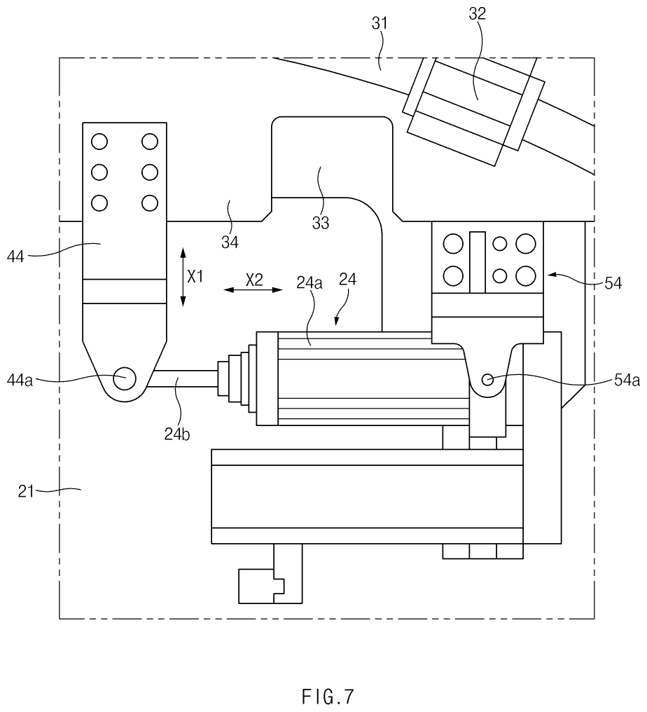

Referring to FIG. 7, the second servo actuator 24 may include a second housing 24a and a second rod 24b moving forward and backward with respect to the second housing 24a. The second housing 24a may be mounted on the top surface of the first intermediate plate 33 through a second bracket 54. Accordingly, the second servo actuator 24 may move the second intermediate plate 34 in the second direction X2 above the top surface of the first intermediate plate 33. The second bracket 54 may be fixed to the first intermediate plate 33, and the second housing 24a may be pivotally connected to the second bracket 54 through a pivot pin 54a. A longitudinal axis of the second housing 24a may extend in the second direction X2, a longitudinal axis of the second rod 24b may extend in the second direction X2, and the second rod 24b may move forward and backward with respect to the second housing 24a in the second direction X2. The second rod 24b may be connected to the second intermediate plate 34 through a second connection block 44. One end of the second connection block 44 may be connected to the second rod 24b through a pivot pin 44a. The other end of the second connection block 44 may be fixed to the second intermediate plate 34 through a plurality of fasteners. A longitudinal axis of the second connection block 44 may extend in the first direction X1. Accordingly, the longitudinal axis of the second connection block 44 may be perpendicular to the longitudinal axis of the second rod 24b. As the second rod 24b moves forward and backward with respect to the second housing 24a in the second direction X2, the second connection block 44 and the second intermediate plate 34 may move in the second direction X2.

Referring to FIG. 5, the third servo actuator 25 may be biased from a central longitudinal axis of the base 21. Referring to FIG. 2, the third servo actuator 25 may be connected to a portion of the moving plate 22 biased from a central longitudinal axis of the moving plate 22. As the third servo actuator 25 moves the moving plate 22 in the second direction X2, the moving plate 22 may rotate around the central point C thereof in the rotation direction R.

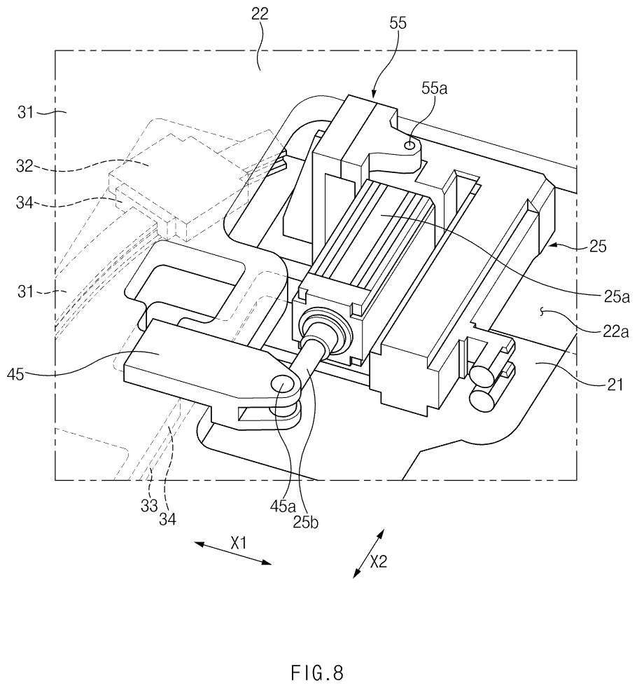

Referring to FIG. 8, the third servo actuator 25 may include a third housing 25a, and a third rod 25b moving forward and backward with respect to the third housing 25a. The third housing 25a may be mounted on the top surface of the second intermediate plate 34 through a third bracket 55. Accordingly, the third servo actuator 25 may rotate the moving plate 22 in the rotation direction R above the top surface of the second intermediate plate 34. The third bracket 55 may be fixed to the top surface of the second intermediate plate 34, and the third housing 25a may be pivotally connected to the third bracket 55 through a pivot pin 55a. A longitudinal axis of the third housing 25a may extend in the second direction X2, and a longitudinal axis of the third rod 25b may extend in the second direction X2. The third rod 25b may move forward and backward with respect to the third housing 25a in the second direction X2. The third rod 25b may be connected to the moving plate 22 through a third connection block 45. One end of the third connection block 45 may be connected to the third rod 25b through a pivot pin 45a, and the other end of the third connection block 45 may be fixed to the moving plate 22 through a plurality of fasteners. A longitudinal axis of the third connection block 45 may extend in the first direction X1. Accordingly, the longitudinal axis of the third connection block 45 may be perpendicular to the longitudinal axis of the third rod 25b. As the third rod 25b moves forward and backward with respect to the third housing 25a in the second direction X2, the third connection block 45 and the moving plate 22 may move in the second direction X2. When the moving plate 22 moves in the second direction X2 by the third servo actuator 25, the moving plate 22 may be guided by the third guide rails 31 and the third guide blocks 32 so that the moving plate 22 may rotate in the rotation direction R.

Referring to FIG. 5, two first intermediate plates 33 may be disposed on the front and rear of the base 21, respectively. The two second intermediate plates 34 may be disposed above the two first intermediate plates 33, respectively. The two third guide rails 31 may be fixed to the top surfaces of the two second intermediate plates 34, respectively.

Referring to FIG. 2, the vehicle component mounting system 10 may include a positioning pin 18 connected to the floating component 11. A pair of positioning pins 18 may be connected to both side edges of the moving plate 22. Accordingly, the pair of positioning pins 18 may move together with the moving plate 22. Referring to FIG. 3, each positioning pin 18 may move upwards and downwards by a positioning pin actuator 68. A pair of support plates 69 may be connected to both side edges of the moving plate 22, and the positioning pin 18 and the positioning pin actuator 68 may be supported to the corresponding support plate 69.

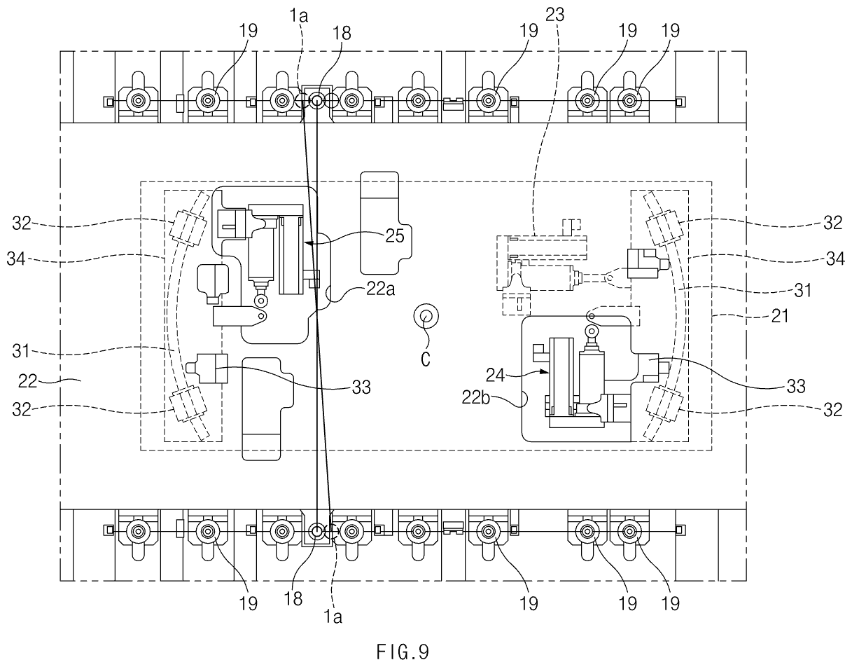

Referring to FIG. 2, the vehicle component mounting system 10 may include a plurality of vision cameras 13 disposed around the floating component 11. The plurality of vision cameras 13 may be disposed symmetrically on both left and right sides of the floating component 11. Each vision camera 13 may move close to or far from the vehicle body 1 by an actuator (not shown). The plurality of vision cameras 13 may photograph a bottom surface of the vehicle body 1 to obtain information on types of the vehicle body 1, position of a positioning hole 1a (see FIG. 9) of the vehicle body 1, and the like.

A controller 100 may be electrically connected to the plurality of vision cameras 13 and the plurality of servo actuators 23, 24, and 25. The position of the positioning pin 18 of the floating component 11 may be previously input to the controller 100, and the vision camera 13 may detect the position of the positioning hole 1a of the vehicle body 1. The controller 100 may be configured to control the servo actuators 23, 24, and 25 of the floating component 11 based on a relative position between the positioning pin 18 of the floating component 11 and the positioning hole 1a of the vehicle body 1. The controller 100 may control the servo actuators 23, 24, and 25 to allow each positioning pin 18 to be aligned with the positioning hole 1a of the vehicle body 1 based on the position of the positioning hole 1a of the vehicle body 1 captured by the vision camera 13. Consequently, the moving plate 22, the skid plate 20, and the vehicle component 2 may be accurately positioned with respect to the vehicle body 1. Thus, the vehicle component 2 may be accurately mounted on the vehicle body 1.

The moving plate 22 may be configured to move from an initial position to a correction position by the plurality of servo actuators 23, 24, and 25. Referring to FIG. 9, the initial position refers to a position in which the positioning pin 18 of the floating component 11 is not aligned with the positioning hole 1a of the vehicle body 1. The correction position refers to a position in which the positioning pin 18 is aligned with the positioning hole 1a of the vehicle body 1 by the movement of the moving plate 22. When the moving plate 22 is in the initial position, the central point C of the moving plate 22 may be aligned with the central point C1 of the base 21. When the moving plate 22 is in the correction position, the central point C of the moving plate 22 may not be aligned with the central point C1 of the base 21.

Referring to FIG. 2, the moving plate 22 may have a plurality of openings 22a and 22b. Referring to FIG. 8, The third housing 25a of the third servo actuator 25 may be located within the first opening 22a of the moving plate 22, and the first opening 22a of the moving plate 22 may be greater than the third housing 25a of the third servo actuator 25. Accordingly, when the moving plate 22 is rotated by the third servo actuator 25, the third servo actuator 25 may be prevented from interfering with the moving plate 22. The second servo actuator 24 may be located within the second opening 22b of the moving plate 22, and the second opening 22b of the moving plate 22 may be greater than the second housing 24a of the second servo actuator 24. Accordingly, when the moving plate 22 moves in the second direction by the second servo actuator 24, the second servo actuator 24 may be prevented from interfering with the moving plate 22.

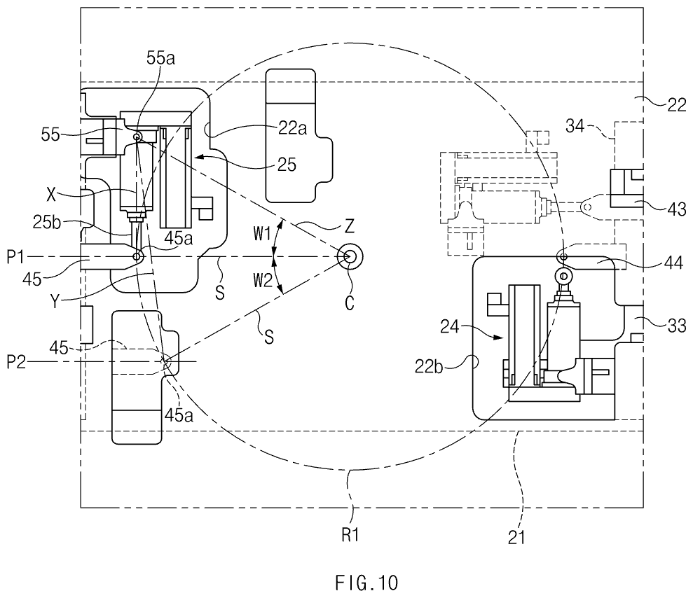

FIG. 10 illustrates an example calculation of a stroke (Y-X) of the third rod 25b of the third servo actuator 25 when the third connection block 45 and the moving plate 22 move from an initial position P1 to a correction position P2 by the third servo actuator 25.

Referring to FIG. 10, the third connection block 45 may move along a rotation path RI defined by a predetermined radius S from the central point C of the moving plate 22 by the third servo actuator 25. When the pivot pin 45a of the third connection block 45 is in the initial position P1, an initial length X of the third housing 25a and the third rod 25b of the third servo actuator 25 may correspond to a distance from the pivot pin 55a of the third bracket 55 to the pivot pin 45a of the third connection block 45. When the pivot pin 45a of the third connection block 45 is in the correction position P2, a correction length Y of the third housing 25a and the third rod 25b of the third servo actuator 25 may correspond to a distance from the pivot pin 55a of the third bracket 55 to the pivot pin 45a of the third connection block 45 after the third connection block 45 moves along the rotation path R1 by the third servo actuator 25. The central point C of the moving plate 22, the pivot pin 55a of the third bracket 55, and the pivot pin 45a of the third connection block 45 may correspond to vertices of a triangle.

A distance Z from the pivot pin 55a of the third bracket 55 to the central point C of the moving plate 22 may be calculated by Equation (1) below.

$${Z}^{2} = {X}^{2} + {S}^{2} \qquad Equation ( 1 )$$

The correction length Y may be calculated by Equation (2) below.

$${Y}^{2} = {Z}^{2} + {S}^{2} - 2 ZS cos ( W 1 + W 2 ) \qquad Equation ( 2 )$$

The stroke (Y-X) of the third rod 25b of the third servo actuator 25 may be calculated by Equation (3) below.

$$Y - X = \sqrt{{Z}^{2} + {S}^{2} - 2 ZS cos ( W 1 + W 2 )} \qquad Equation ( 3 )$$

Here, when the pivot pin 45a of the third connection block 45 is in the initial position P1, a first angle W1 defined by the third rod 25b of the third servo actuator 25 may be predetermined, and when the pivot pin 45a of the third connection block 45 moves to the correction position P2, a second angle W2 defined by the third rod 25b of the third servo actuator 25 after rotation may be calculated by the controller 100.

Referring to FIG. 2, the vehicle component mounting system 10 may include a plurality of fastening tools 19 disposed around the floating component 11. The plurality of fastening tools 19 may be connected to both side edges of the moving plate 22. After the positioning pin 18 is aligned with the positioning hole la of the vehicle body 1 by the movement of the moving plate 22, each fastening tool 19 may put a fastener in a mounting hole of the vehicle body 1 and a mounting hole of the vehicle component 2 so that the vehicle body 1 and the vehicle component 2 may be fastened. For example, the fastening tool 19 may be a nut runner used to mount the fastener in the mounting hole of the vehicle body 1 and the mounting hole of the vehicle component 2.

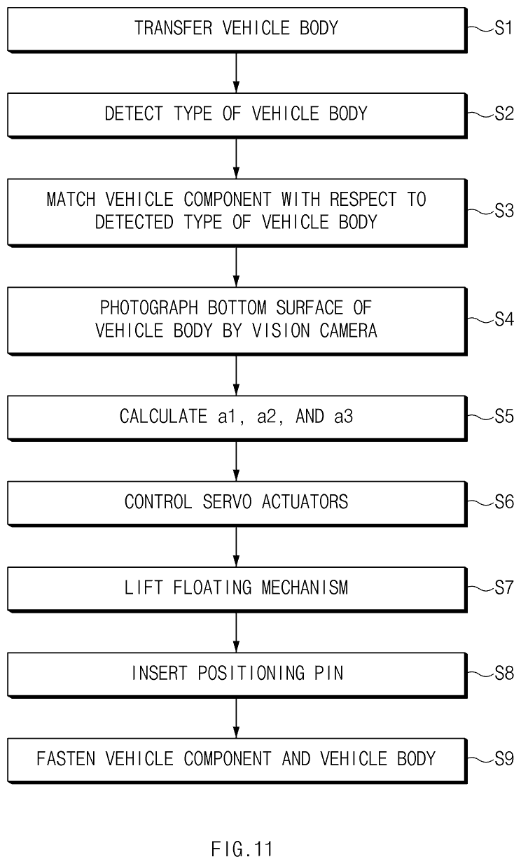

FIG. 11 illustrates an example flowchart of a method of controlling a vehicle component mounting system of the present disclosure.

At S1, the vehicle body 1 may be transferred above the vehicle component mounting system 10 by the transfer component. At S2, type of the vehicle body 1 may be detected by the sensors 65, the vision cameras 13, and the like. At S3, controller 100 may match the vehicle component 2 with respect to the detected type of the vehicle body 1.

At S4, the plurality of vision cameras 13 may move close to the vehicle body 1, and the plurality of vision cameras 13 may photograph the bottom surface of the vehicle body 1. At S5, controller 100 may calculate a first-direction correction value a1, a second-direction correction value a2, and a rotation-direction correction value a3 of the moving plate 22 based on the position of the positioning hole 1a of the vehicle body 1 photographed by the vision cameras 13 and a distance between the positioning hole 1a of the vehicle body 1 and the positioning pin 18 of the floating component 11.

At S6, controller 100 may control the first servo actuator 23, the second servo actuator 24, and the third servo actuator 25 based on the first-direction correction value al, the second-direction correction value a2, and the rotation-direction correction value a3. As the moving plate 22 moves in the first direction X1, the second direction X2, and the rotation direction R by the first servo actuator 23, the second servo actuator 24, and the third servo actuator 25, the positioning pin 18 may be aligned with the positioning hole 1a of the vehicle body 1.

Then, at S7, the floating component 11 may be lifted toward the vehicle body 1 by the lifting component 12. As the positioning pin 18 moves upwards to the positioning hole 1a of the vehicle body 1 by the actuator 68, the positioning pin 18 may be inserted into the positioning hole 1a of the vehicle body 1 at S8. Accordingly, the vehicle component 2 may be accurately positioned with respect to the vehicle body 1. In this state, the plurality of fastening tools 19 may fasten the vehicle component 2 to the vehicle body 1 through the fasteners at S9. Thus, the vehicle component 2 may be accurately mounted on the vehicle body 1.

After the vehicle component 2 is mounted on the vehicle body 1, the positioning pin 18 may move downwards, and the floating component 11 may move downwards by the lifting component 12. Then, the floating component 11 may return to the initial position by the first servo actuator 23, the second servo actuator 24, and the third servo actuator 25, and the vehicle body 1 may be taken out by the transfer component.

The vision cameras 13 may photograph the positioning hole 1a of the vehicle body 1, and the servo actuators 23, 24, and 25 may move the moving plate 22 of the floating component 11 so that the positioning pin 18 connected to the floating component 11 may be accurately aligned with the positioning hole 1a of the vehicle body 1. Thus, the vehicle component 2 may be accurately positioned and mounted with respect to the vehicle body 1.

According to an example of the present disclosure, a vehicle component mounting system may include: a floating component configured to move a vehicle component below a vehicle body; a positioning pin connected to the floating component; a vision camera configured to photograph a positioning hole of the vehicle body; and a controller configured to control a movement of the floating component based on a position of the positioning hole of the vehicle body photographed by the vision camera.

The vehicle component mounting system may further include a lifting component configured to move the floating component upwards and downwards.

The floating component may include a base fixed to the lifting component, a moving plate disposed to be movable above the base, and a plurality of servo actuators configured to move the moving plate.

The vehicle component mounting system may further include a skid plate configured to convey the vehicle component above the moving plate.

The plurality of servo actuators may include a first servo actuator configured to move the moving plate in a first direction, a second servo actuator configured to move the moving plate in a second direction, and a third servo actuator configured to rotate the moving plate in a rotation direction.

The floating component may further include a first intermediate plate configured to move in the first direction by the first servo actuator above the base, and a second intermediate plate configured to move in the second direction by the second servo actuator above the first intermediate plate.

The floating component may further include a first guide rail and a first guide block configured to guide a movement of the first intermediate plate. The first guide rail may be disposed on a top surface of the base and extend in the first direction, and the first guide block may be fixed to a bottom surface of the first intermediate plate.

The floating component may further include a second guide rail and a second guide block configured to guide a movement of the second intermediate plate. The second guide rail may be disposed on a top surface of the first intermediate plate and extend in the second direction, and the second guide block may be fixed to a bottom surface of the second intermediate plate.

The floating component may further include a third guide rail and a third guide block configured to guide a rotation of the moving plate. The third guide rail may be disposed on a top surface of the second intermediate plate and extend curvedly to have a constant radius of curvature from a central point of the moving plate, and the third guide block may be fixed to a bottom surface of the moving plate.

The first servo actuator may include a first housing mounted on a top surface of the base, and a first rod moving forward and backward with respect to the first housing, and the first rod may be connected to the first intermediate plate.

The second servo actuator may include a second housing mounted on a top surface of the first intermediate plate, and a second rod moving forward and backward with respect to the second housing, and the second rod may be connected to the second intermediate plate.

The third servo actuator may include a third housing mounted on a top surface of the second intermediate plate, and a third rod moving forward and backward with respect to the third housing, and the third rod may be connected to the moving plate.

The vehicle component mounting system may further include a fastening tool disposed around the floating component, and the fastening tool may be configured to fasten the vehicle component to the vehicle body.

As set forth above, the vehicle component mounting system may be configured to have the vision cameras photograph the positioning hole(s) of the vehicle body, and may allow the servo actuators to move the moving plate of the floating component based on the position of the positioning hole(s) of the vehicle body. In this way, the vehicle component mounting system may accurately align the positioning pin(s) connected to the floating component with the positioning hole(s) of the vehicle body. Thus, the vehicle component(s) may be accurately positioned and mounted with respect to various types of vehicle bodies.

Hereinabove, although the present disclosure has been described with reference to the examples above and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle component mounting system, comprising:
a floating component configured to move a vehicle component below a vehicle body;
a positioning pin connected to the floating component;
a vision camera configured to photograph a positioning hole of the vehicle body; and
a controller configured to control a movement of the floating component based on a position of the positioning hole of the vehicle body photographed by the vision camera.

2. The vehicle component mounting system according to claim 1, further comprising a lifting device configured to move the floating component upwards and downwards.

3. The vehicle component mounting system according to claim 2, wherein the floating component comprises:
a base fixed to the lifting device;
a moving plate disposed to be movable above the base; and
a plurality of servo actuators configured to move the moving plate.

4. The vehicle component mounting system according to claim 3, further comprising a skid plate configured to convey the vehicle component above the moving plate.

5. The vehicle component mounting system according to claim 3, wherein the plurality of servo actuators comprises:
a first servo actuator configured to move the moving plate in a first direction;
a second servo actuator configured to move the moving plate in a second direction; and
a third servo actuator configured to rotate the moving plate in a rotation direction.

6. The vehicle component mounting system according to claim 5, wherein the floating component further comprises:
a first intermediate plate configured to move in the first direction by the first servo actuator above the base; and
a second intermediate plate configured to move in the second direction by the second servo actuator above the first intermediate plate.

7. The vehicle component mounting system according to claim 6, wherein the floating component further comprises:
a first guide rail; and
a first guide block configured to guide a movement of the first intermediate plate, and wherein
the first guide rail is disposed on a top surface of the base and extends in the first direction, and
the first guide block is fixed to a bottom surface of the first intermediate plate.

8. The vehicle component mounting system according to claim 6, wherein the floating component further comprises:
a second guide rail; and
a second guide block configured to guide a movement of the second intermediate plate, and wherein
the second guide rail is disposed on a top surface of the first intermediate plate and extends in the second direction, and
the second guide block is fixed to a bottom surface of the second intermediate plate.

9. The vehicle component mounting system according to claim 6, wherein the floating component further comprises:
a third guide rail; and
a third guide block configured to guide a rotation of the moving plate, and wherein
the third guide rail is disposed on a top surface of the second intermediate plate and extends curvedly to have a constant radius of curvature from a central point of the moving plate, and
the third guide block is fixed to a bottom surface of the moving plate.

10. The vehicle component mounting system according to claim 6, wherein the first servo actuator comprises:
a first housing mounted on a top surface of the base; and
a first rod moving forward and backward with respect to the first housing, and wherein the first rod is connected to the first intermediate plate.

11. The vehicle component mounting system according to claim 6, wherein the second servo actuator comprises:
a second housing mounted on a top surface of the first intermediate plate; and
a second rod moving forward and backward with respect to the second housing, and wherein the second rod is connected to the second intermediate plate.

12. The vehicle component mounting system according to claim 6, wherein the third servo actuator comprises:
a third housing mounted on a top surface of the second intermediate plate; and
a third rod connected to the moving plate, the third rod is configured to move forward and backward with respect to the third housing.

13. The vehicle component mounting system according to claim 1, further comprising a fastening tool disposed around the floating component,
wherein the fastening tool is configured to fasten the vehicle component to the vehicle body.

14. A vehicle component mounting system, comprising:
a floating component configured to move a vehicle component below a vehicle body;
a lifting device configured to move the floating component upwards and downwards;
a base fixed to the lifting device;
a moving plate disposed to be movable above the base;
a plurality of servo actuators configured to move the moving plate; and
a controller configured to control a movement of the floating component via the plurality of servo actuators to accurately position the vehicle component to the vehicle body.

15. The vehicle component mounting system according to claim 14, wherein the plurality of servo actuators comprises:
a first servo actuator configured to move the moving plate in a first direction;
a second servo actuator configured to move the moving plate in a second direction perpendicular to the first direction; and
a third servo actuator configured to rotate the moving plate in a rotation direction.

16. The vehicle component mounting system according to claim 15, wherein the floating component further comprises:
a first intermediate plate configured to move in the first direction by the first servo actuator above the base; and
a second intermediate plate configured to move in the second direction by the second servo actuator above the first intermediate plate,
wherein the first servo actuator comprises:
a first housing mounted to a top surface of the base; and
a first rod, connected the first intermediate plate, configured to move forward and backward with respect to the first housing, and
wherein the second servo actuator comprises:
a second housing mounted to a top surface of the first intermediate plate; and
a second rod, connected to the second intermediate plate, configured to move forward and backward with respect to the second housing.

17. The vehicle component mounting system according to claim 14, further comprising:
a positioning pin connected to the floating component;
a vision camera configured to photograph a positioning hole of the vehicle body; and
the controller configured to control the movement of the floating component based on a position of the positioning hole of the vehicle body photographed by the vision camera.

18. A vehicle component mounting system, comprising:
a first component configured to move a vehicle component below a vehicle body, the first component comprising:
a base;
a moving plate located above the base and configured to move relative to the base;
a first intermediate plate located below the moving plate;
a second intermediate plate located parallel to the first intermediate plate;
a guide rail positioned between the first intermediate plate and the second intermediate plate; and
a plurality of servo actuators configured to move the moving plate,
a lifting device configured to move the first component upwards and downwards, wherein the base of the first component is fixed to the lifting device;
a positioning pin connected to the first component;
a camera configured to photograph a positioning hole of the vehicle body; and
a controller configured to control a movement of the first component via the plurality of servo actuators based on a position of the positioning hole of the vehicle body photographed by the camera.

19. The vehicle component mounting system according to claim 18, wherein the plurality of servo actuators comprises:
a first servo actuator configured to move the moving plate in a first direction;
a second servo actuator configured to move the moving plate in a second direction; and
a third servo actuator configured to rotate the moving plate in a rotation direction.

20. The vehicle component mounting system according to claim 19, wherein the first component further comprises:
the first intermediate plate configured to move in the first direction by the first servo actuator above the base; and
the second intermediate plate configured to move in the second direction by the second servo actuator above the first intermediate plate.
